(19) United States
(12) Patent Application Publication
(10) Pub. No.: US 2019/0283622 A1
(43) Pub. Date: Sep. 19, 2019

(54) NOTIFICATION SYSTEM, NOTIFICATION METHOD, AND NON-TRANSITORY COMPUTER-READABLE STORAGE MEDIUM STORING PROGRAM

(71) Applicant: HONDA MOTOR CO., LTD., Tokyo (JP)

(72) Inventor: Kazuya Watanabe, Wako-shi (JP)

(73) Assignee: HONDA MOTOR CO., LTD., Tokyo (JP)

(21) Appl. No.: 16/292,702

(22) Filed: Mar. 5, 2019

(30) Foreign Application Priority Data
Mar. 19, 2018 (JP) 2018-051146

(51) Int. Cl. B60L 58/12; G06F 9/54

(52) U.S. Cl. CPC B60L 58/12; G06F 9/542; B60L 2240/622; B60L 2250/20; B60L 2250/12; B60L 2240/70

(57) ABSTRACT

An obtaining unit obtains a next use plan of a vehicle, which is made by a user of the vehicle. A notification unit, if it is determined based on the next use plan obtained by the obtaining unit that it is necessary to replenish driving energy of the vehicle, performs notification about replenishment of the driving energy of the vehicle during current use of the vehicle.

### CROSS-REFERENCE TO RELATED APPLICATION(S)

This application claims priority to and the benefit of Japanese Patent Application No. 2018-051146 filed on Mar. 19, 2018, the entire disclosure of which is incorporated herein by reference.

### BACKGROUND OF THE INVENTION

### Field of the Invention

The present invention relates to a notification system and a notification method which notify information about driving energy of a vehicle, and a non-transitory computer-readable storage medium storing a program.

### Description of the Related Art

Japanese Patent Laid-Open No. 2003-294458 describes a method of notifying a driver of an optimum refueling method by taking account of, for example, a fuel price which varies daily in accordance with an area, station, brand, and the like, a remaining fuel amount, fuel efficiency prediction, and a planned travel route (for example, the next gas station which a self-vehicle is scheduled to pass).

By making a driving energy replenishment plan such as refueling or recharging in a travel route of the day efficient travel to the destination of the day can be realized. However, a vehicle use plan for the next time from the following day is not taken into consideration. For example, if the residual fuel amount or residual battery capacity is very small when departing to the destination on the following day, refueling or recharging must be performed en route to the destination. In this case, the route or the time of arrival must be changed although it is originally unnecessary to perform refueling or recharging on a route to the destination if the residual fuel amount or residual battery capacity is sufficient.

### SUMMARY OF THE INVENTION

An aspect of the present invention is to eliminate the above-mentioned problems with the conventional technology. The present invention provides a notification system and notification method which notify the timing of replenishment of driving energy based on a next vehicle use plan, and a non-transitory computer-readable storage medium storing a program.

The present invention in its first aspect provides a notification system comprising: an obtaining unit configured to obtain a next use plan of a vehicle, which is made by a user of the vehicle; and a notification unit configured to, if it is determined based on the next use plan obtained by the obtaining unit that it is necessary to replenish driving energy of the vehicle, perform notification about replenishment of the driving energy of the vehicle during current use of the vehicle.

The present invention in its second aspect provides a notification method to be executed in a notification system which notifies replenishment of driving energy of a vehicle, comprising obtaining a next use plan of a vehicle, which is made by a user of the vehicle; and if it is determined based on the next use plan obtained in the obtaining that it is necessary to replenish driving energy of the vehicle, performing notification about replenishment of the driving energy of the vehicle during current use of the vehicle.

The present invention in its third aspect provides, a non-transitory computer-readable storage medium storing a program which causes a computer to function so as to: obtain a next use plan of a vehicle, which is made by a user of the vehicle; and if it is determined based on the obtained next use plan that it is necessary to replenish driving energy of the vehicle, perform notification about replenishment of the driving energy of the vehicle during current use of the vehicle.

The present invention can notify the timing of replenishment of driving energy based on a next vehicle use plan.

Further features of the present invention will become apparent from the following description of exemplary embodiments with reference to the attached drawings.

### BRIEF DESCRIPTION OF THE DRAWINGS

FIG. 1 is a view showing the configuration of a system;

FIG. 2A is a view showing the configuration of a server;

FIG. 2B is a view showing the configuration of a wireless base station;

FIG. 3 is a view showing the configuration of a vehicle;

FIG. 4A is a view for explaining notification of the timing of energy replenishment;

FIG. 4B is a view for explaining notification of the timing of energy replenishment;

FIG. 4C is a view for explaining notification of the timing of energy replenishment;

FIG. 5 is a flowchart showing an energy replenishment timing notification process;

FIG. 6 is a flowchart showing a process of estimating an energy consumption amount on a future action plan execution day;

FIG. 7 is a flowchart showing a process of determining notification of the timing of energy replenishment;

FIG. 8 is a flowchart showing a process of estimating a residual energy amount at the start timing of flame action plan execution; and

FIG. 9 is a view associating the energy replenishment timing notification process with the driving state of the vehicle.

### DESCRIPTION OF THE EMBODIMENTS

Embodiments of the present invention will be explained below with reference to the accompanying drawings. Note that the same reference numerals denote the same constituent elements, and an explanation thereof will be omitted.

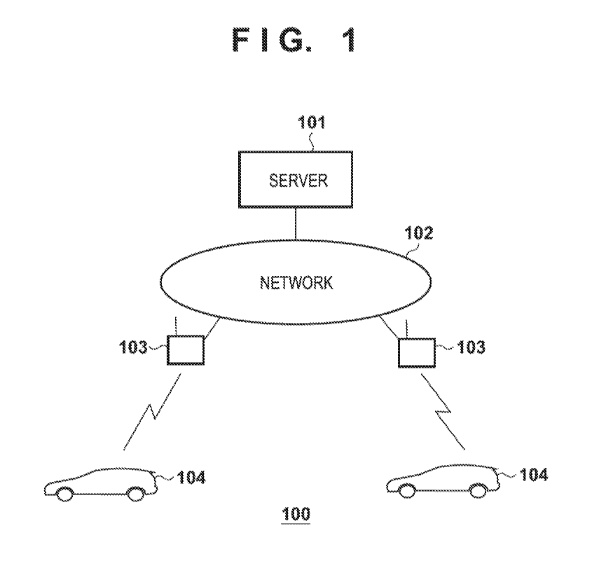

FIG. 1 is a view showing the configuration of a driving energy replenishment timing notification system. As shown in FIG. 1, a notification system 100 is so configured that a server 101 and wireless base stations 103 can communicate with each other across a network 102 including a wired or wireless medium. In this embodiment, a vehicle 104 will be explained as an electric vehicle such as a plug-in hybrid car incorporating a chargeable battery. Driving energy (to be simply referred to as energy hereinafter) for driving the vehicle 104 is electric energy. The energy includes not only electric energy but also fuel. In the notification system 100, an occupant of the vehicle 104 is notified of the timing of charging the battery of the vehicle 104, based on a use plan of the vehicle 104 made by the user of the vehicle 104.

The wireless base station 103 is installed in a public facility such as a traffic signal, and relays data transmitted from the vehicle 104 to the server 101 across the network 102. The data transmitted from the vehicle 104 contains, for example, identification information of the occupant of the vehicle 104 and GPS information of the vehicle 104. For the sake of explanation, one wireless base station 103 corresponds to one vehicle 104 in FIG. 1. However, one wireless base station 103 corresponds to a plurality of vehicles 104 in some cases.

Based on the data transmitted from the vehicle 104, the server 101 estimates the residual capacity of the battery for the case where the use plan of the vehicle 104 from the following day has been executed. If it determines that the battery will be insufficient to execute the use plan, the server 101 notifies the occupant that the energy replenishment timing has come. With this configuration, when the occupant is going home from the workplace by the vehicle 104 on Friday and is planning to go to a golf course two days later on Sunday, the server 101 notifies the occupant that it is necessary to charge the battery at a charging spot en route to the home. Consequently, it is possible to avoid a situation in which the residual capacity of the battery becomes very small and the battery must be charged during the action on Sunday.

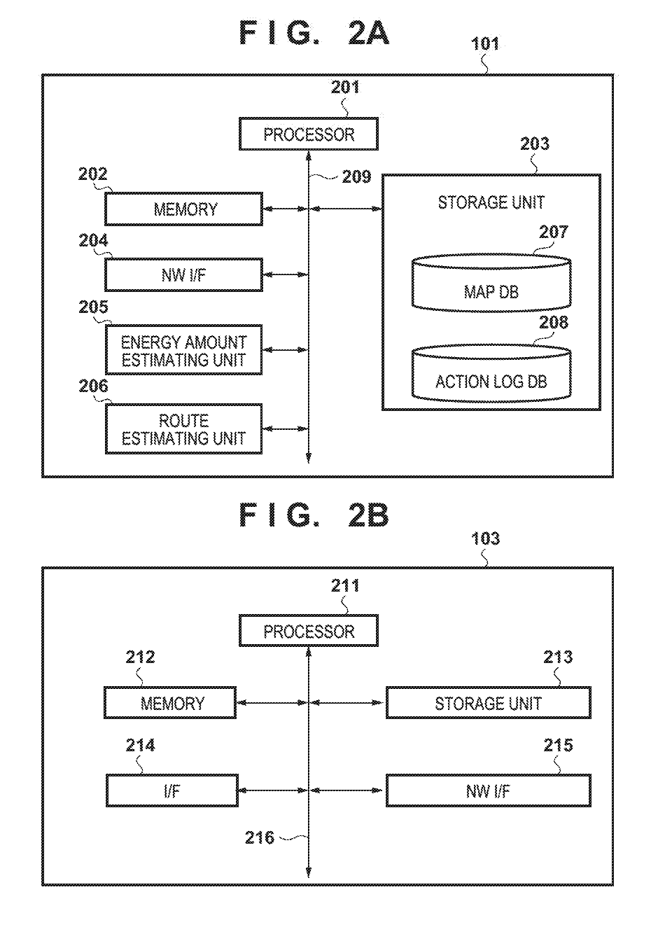

FIG. 2A is a view showing the configuration of the server 101. A processor 201 comprehensively controls the server 101. For example, the processor 201 implements the operation of this embodiment by reading out a control program stored in a storage unit 203 to a memory 202 as an example of a storage medium, and executing the program. A network interface (NW I/F) 204 is an interface for enabling communication with the network 102, and has an arrangement corresponding to the medium of the network 102.

The storage unit 203 stores data, parameters, programs, and the like necessary for the operation of the server 101. Also, the storage unit 203 includes various databases (DBs), such as a map DB 207 and an action log DB 208. The map DB 207 is a map DB containing road information, facility information, and traffic information, and also contains charging spot information. The action log DB 208 stores the action log of each occupant of the vehicle 104. For example, an action log indicating that a person A drove the vehicle 104 as a user of the vehicle 104 on Jan. 12, 2018 is stored by being associated with the person A, and an action log indicating that a person B drove the vehicle 104 as a user of the vehicle 104 on Jan. 30, 2018 is stored by being associated with the person B.

An action log of an occupant is, for example, information of a route on which the occupant drove the vehicle 104 in the past. For example, GPS information received from the vehicle 104 is stored as the action log. For example, route information of the vehicle 104 when an occupant went to a ski resort in Hokkaido in the past is stored. Also, the processor 201 daily collects calendar information and SNS information of each occupant as big data in the storage unit 203. For example, when a given user registers him or her on the server 101 of the notification system 100, the processor 201 collects calendar information and SNS information of the registered user, and stores the collected information in the storage unit 203. Based on the calendar information and SNS information, the storage unit 203 stores, in time series, the use plans of the vehicle 104 made by one or a plurality of users or prospective users of the vehicle 104, like the examples of the persons A and B described above.

A route estimating unit 206 obtains a use plan of the vehicle 104 in the future (from the following day) from the calendar information and SNS information stored in the storage unit 203, and estimates a travel route of the vehicle 104 in the use plan. When estimating the travel route, the route estimating unit 206 sometimes uses past route information stored in the action log DB 208. An energy amount estimating unit 2.05 estimates an energy amount to be consumed in a future use plan. In this embodiment, the energy amount estimating unit 205 estimates an energy amount to be used on the travel route estimated by the route estimating unit 206. As a second energy consumption amount, the energy amount estimating unit 205 also estimates an energy amount other than a first energy amount to be consumed on the travel route. For example, the second energy consumption amount is an energy amount to be consumed in a connection between the vehicle 104 and an apparatus other than the vehicle 104, and is an energy amount necessary to charge a portable terminal in the vehicle 104. In this embodiment, the vehicle 104 is an electric vehicle, so the first and second energy consumption amounts in this case are the consumption amounts of the battery. On the other hand, the first energy consumption amount may also be the residual fuel amount. The individual blocks shown in FIG. 2A can communicate with each other via a bus 209.

FIG. 2B is a view showing the configuration of the wireless base station 103. A processor 211 comprehensively controls the wireless base station 103 by reading out a control program stored in a storage unit 213 to a memory 212 and executing the program. A network interface (NW I/F) 215 is an interface for enabling communication with the network 102, and has an arrangement corresponding to the medium of the network 102. An interface (I/F) 214 is a wireless communication interface to the vehicle 104, and the wireless base station 103 receives data from the vehicle 104 by the I/F 214. The received data is converted, and the converted data is transmitted to the server 101 across the network 102 by the NW I/F 215. The individual blocks shown in FIG. 2B can communicate with each other via a bus 216.

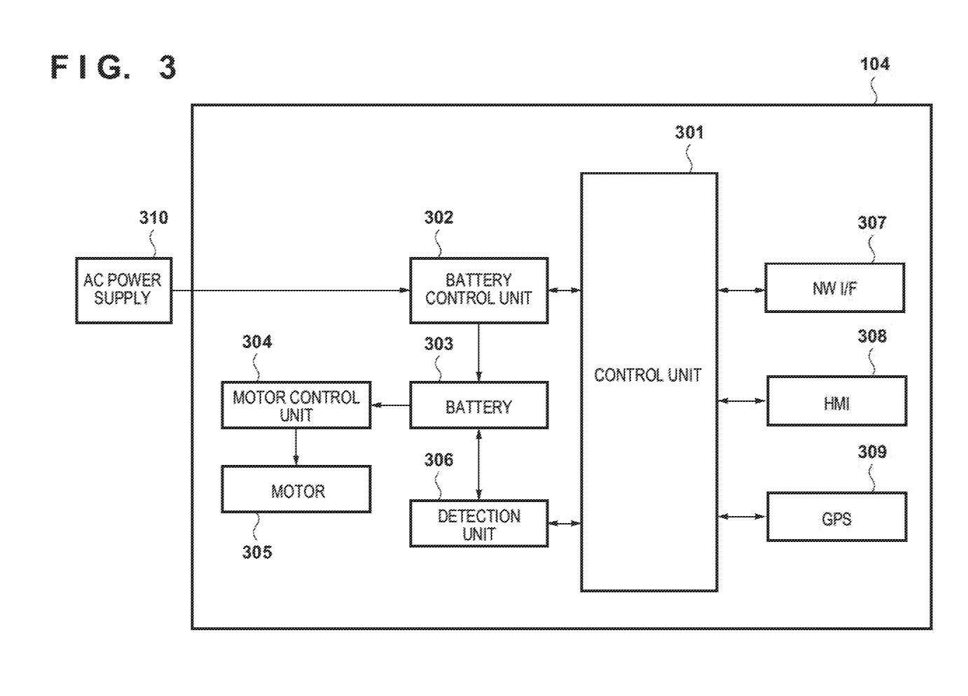

FIG. 3 is a view showing the configuration of the vehicle 104. FIG. 3 shows the arrangement of main blocks around the battery. A control unit 301 includes an ECU for determining the charring state (for example, fully charged or not, and the residual capacity) of a battery 303 based on detection information from a detection unit 306, and an ECU for executing an energy replenishment timing notification process according to this embodiment.

A battery control unit 302 detects a connection between the vehicle 104 and an external AC power supply 310, and charges, the battery 303 by using, a charger. The battery 303 is a battery chargeable by electric power supplied from the external AC power supply 310. The detection unit 306 detects the residual capacity, temperature, and the like of the battery 303, and transmits the detection signal to the control unit 301. A motor control unit 304 includes an inverter which converts the voltage of the battery 303 into a driving voltage and supplies the driving voltage to a motor 305. The motor 305 allows the vehicle 104 to travel by the driving voltage supplied from the motor control unit 304.

The control unit 301 transmits data containing the occupant identification information and GPS information to the wireless base station 103 via a network interface (NW I/F) 307. As the occupant identification information, for example, imaging data captured by a camera installed in the vehicle 104, data representing the feature amount, and the like are transmitted to the wireless base station 103 via the NW I/F 307. An HMI 308 is a human-machine interface. The HMI 308 includes a display as a display unit, and displays a screen for displaying notification information indicating that, for example, the residual capacity of the battery 303 is small. A GPS 309 detects the current position of the vehicle 104.

Each of the configurations shown in FIGS. 2A to 3 explained above can be a computer for performing the present invention according to the program.

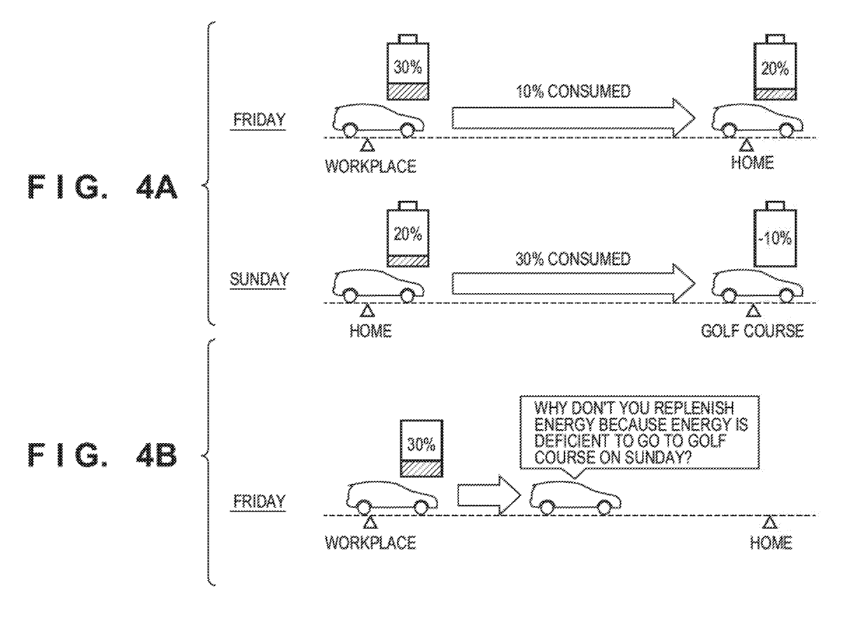

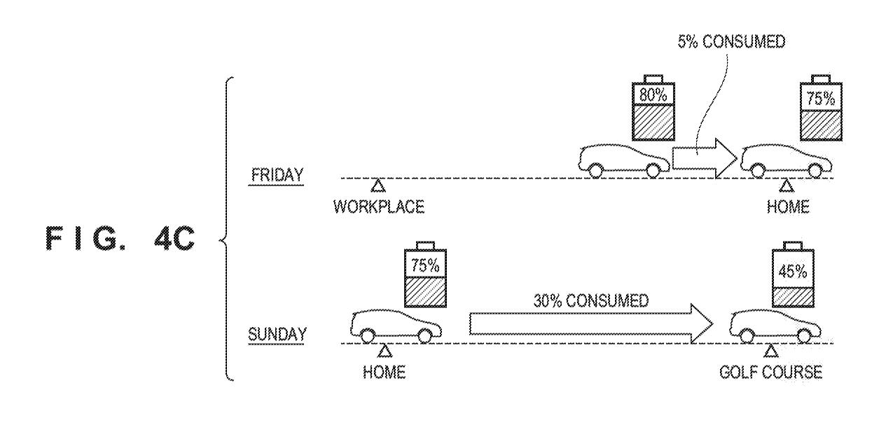

The operation of this embodiment will be explained with reference to FIGS. 4A to 4C. As an example, a state in which an occupant A goes home from the workplace by the vehicle 104 on Friday will be explained. As shown in FIG. 4A, the residual capacity of the battery 303 when the occupant A departs from the workplace is 30%. Since 10% of the battery 303 is consumed by travel from the workplace to the home, the residual capacity of the battery 303 is 20% when the occupant A arrives at the home.

The occupant A is planning to go to a golf course by the vehicle 104 two days later on Sunday. Travel from the home to the golf course consumes of the battery 303. Since the residual capacity of the battery 303 is 20% when the occupant A departs from the home on Sunday, the energy is short by 10% to go to the golf course. Accordingly, the occupant A must replenish energy (in this embodiment, charge the battery 303) on a route from the home to the golf course.

In a situation like this, there is the possibility that the vehicle 104 deviates from the route to the golf course or the time of arrival at the golf course is delayed. In this embodiment, therefore, if it is determined that the possibility like this occurs, the occupant A is notified of the timing of charging the battery 303 when using the vehicle 104 (in this example, when he or she is going home on Friday) before the day (Sunday) on which he or she goes to the golf course. For example, as shown in FIG. 4B, the HMI 308 displays a message “Why don't you replenish energy because energy is insufficient to go to golf on Sunday?” on a route from the workplace to the home.

Then, the occupant stops at a charging spot in order to charge the battery 303. A charging spot is an energy replenishing place, and the energy replenishing place is a gas station or the like when the energy is fuel. FIG. 4C shows that the residual capacity of the battery 303 becomes 80% as a result of charging. When the vehicle arrives at the home, 5% of the battery 303 has been consumed by travel, so the residual capacity of the battery 303 is 75%.

On Sunday shown in FIG. 4C, the residual capacity of the battery 303 is 75% when the vehicle departs from the home. Since travel from the home to the golf course consumes 30% of the battery 303, the vehicle can arrive at the golf course without charging the battery 303.

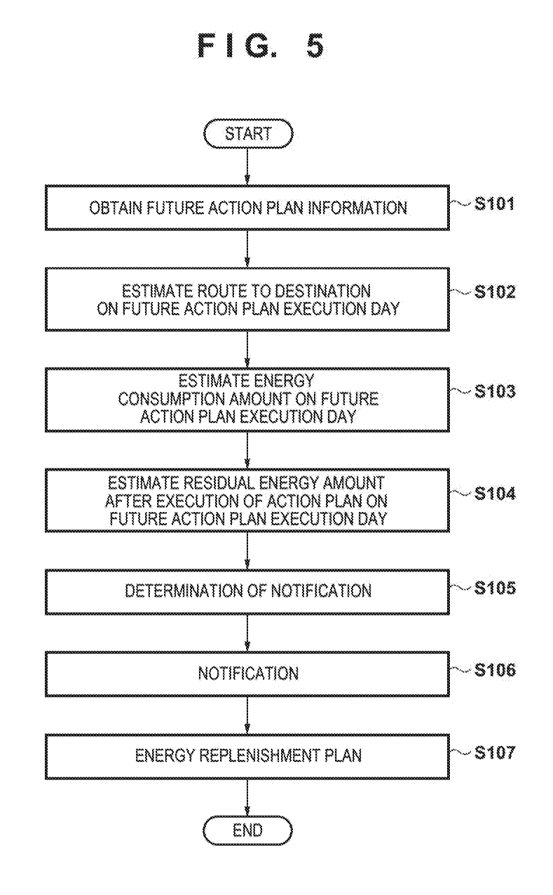

FIG. 5 is a flowchart showing an energy replenishing timing notification process according to this embodiment. The notification system 100 executes the energy replenishing tuning notification process. FIG. 5 will be explained by assuming that the processor 201, the energy amount estimating unit 205, and the we estimating unit 206 of the server 101 implement processing in steps S101 to S105 and S107, and the control unit 301 of the vehicle 104 implements processing in step S106. However, the vehicle 104 may also execute at least a part of the processing to be executed by the server 101.

When the registered user of the notification system 100 gets in the vehicle 104 and inputs an instruction via the HMI 308, the control unit 301 of the vehicle 104 transmits data necessary for the energy replenishing timing, notification process to the wireless base station 103 via the NW I/F 307. The data necessary for the energy replenishing timing notification process is, for example, data indicating information of the occupant. An example is data obtained by imaging the face of the occupant by a camera installed in the vehicle 104. It is also possible to transmit data obtained by extracting feature amounts, instead of the imaging data of the occupant, or transmit both data.

Note that the process shown in FIG. 5 is stalled at the timing at which the occupant returns from the destination to the origin. That is, referring to FIGS. 4A to 4C, the process shown in FIG. 5 is not executed at the timing at which the occupant goes from the home to the workplace on Friday, but executed on a route from the workplace to the home. This is so because the occupant probably has spare time when he or she is returning from the destination (workplace) to the origin (home), when compared to the timing at which he or she is heading for the destination, and hence this is an appropriate timing for stopping at a charging spot,

The process shown in FIG. 5 can be started when the processor 201 obtains an action plan of the day from the calendar information and SNS information of the occupant of the vehicle 104, and determines that the occupant is returning from the destination to the origin (that is, the occupant is moving on the return route) based on position information of the vehicle 104 and time information. For example, the processor 201 of the server 101 obtains the position of “home” of the current occupant of the vehicle 104 from the calendar information and SNS information. As the position of “home”, the driving start point of the vehicle 104 on the day may also be registered in the vehicle 104 as “home” (the abovementioned origin). The processor 201 may also obtain the position of “home” from registration information of the occupant as a registered user of the system shown in FIG. 1. After obtaining the position of “home”, the processor 201 monitors the position information of the vehicle 104, and estimates whether the vehicle 104 is moving to the position of “home” as a destination. For example, the processor 201 can estimate that the vehicle 104 is moving on the return route at a predetermined reliability or more, from a plurality of characteristic elements extracted from the behavior of the vehicle 104. Examples of the characteristic elements are a travel time zone, a travel route, information of an occupant (for example, an unregistered user or not, and the number of occupants), and information about a stop of the vehicle for a predetermined time of more (for example, a stop place). A return route determination unit for determining whether the vehicle is moving on the return route can be formed in the server 101 in place of the processor 201, and this return route determination unit can perform the process as described above.

In step S101, the processor 201 of the server 101 obtains future action plan information of the occupant of the vehicle 104. The future action plan information is obtained from, for example, calendar information and SNS information stored in the storage unit 203 and corresponding to the occupant. The future action plan information is, for example, information indicating, that the occupant goes to a golf course in ◯◯ city of Nagano prefecture on Sunday. The processor 201 transmits the obtained future action plan information to the energy amount estimating unit 205 and the route estimating unit 206. This embodiment will be explained by assuming that the future action plan information of the occupant of the vehicle 104 is obtained. However, the current use that is, the current occupant) of the vehicle 104 may also be different from a user when executing the future action plan. In this case, the processor 201 refers to the storage unit to search for an action plan using the vehicle 104 that is nearest in time series, and obtains the action plan.

In step S102, the route estimating unit 206 estimates a route to the destination on the future action plan execution day, based on the future action plan information obtained in step S101. For example, referring to FIGS. 4A to 4C, the route estimating unit 206 estimates a route to the golf course on Sunday. The route estimating unit 206 estimates the route by referring to, for example, the map DB 207. When estimating the route, if the action log DB 208 has a log having the same or similar contents, for example, a log indicating that the user went to the same golf course in the past, the route estimating unit 206 may also refer to route information indicated by the log. With this configuration, the route can be estimated more reliably. Similar contents are that if the past schedule contains “work” and “Alaska” as the destination, the route estimating unit 206 sets “Alaska” as the destination when the future action plan information contains “workplace”. It is also possible to transmit, to the vehicle 104, display data which encourages the occupant to confirm candidates of routes on which the vehicle 104 can be used in accordance with the destination, and estimate a route in response to the result of designation by the occupant.

In step S103, the energy amount estimating unit 205 estimates an energy consumption amount on the future action plan execution day.

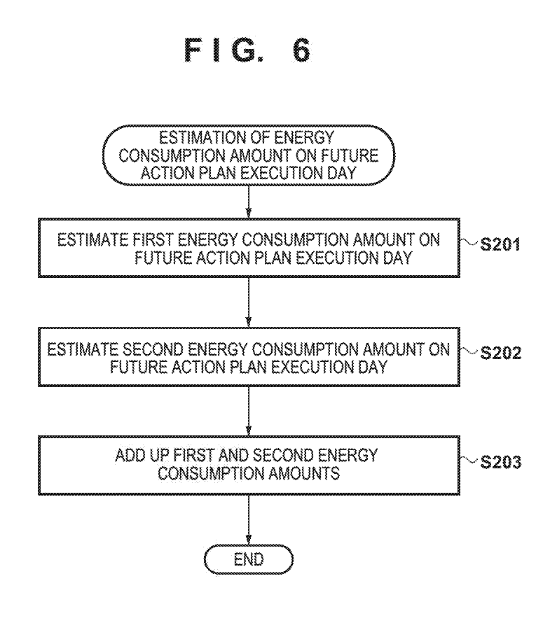

FIG. 6 is a flowchart showing an energy consumption amount estimating process on the future action plan execution day in step S103. In step S201, the energy amount estimating unit 205 estimates a first energy consumption amount on the future action plan execution day. The energy amount estimating unit 205 estimates the first energy consumption amount based on the route information, for example, distance information, estimated in step S102.

In step S202, the energy amount estimating unit 205 estimates a second energy consumption amount on the future action plan execution day. For example, the energy amount estimating unit 205 estimates the second energy consumption amount based on energy amounts consumed by the display device, audio system, and air-conditioning system of the vehicle 104 and consumed by charging a portable terminal. The energy amount estimating unit 205 may also refer to the action log DB 208 when estimating the first and second energy consumption amounts. If the action log DB 208 has a log having the same or similar contents, for example, a log indicating that the user went to the same golf course in the past, the energy amount estimating unit 205 may also refer to energy consumption amounts indicated by the log. With this configuration, the energy consumption amounts can be estimated more reliably.

In step S203, the energy amount estimating unit 205 calculates the sum of the first energy consumption amount estimated in step S201 and the second energy consumption amount estimated in step S202. After that, the process shown in FIG. 6 is terminated.

FIG. 5 will be explained again. In step S104, the energy amount estimating unit 205 estimates a residual energy amount after the action plan is executed on the future action plan execution day. In step S104, the energy amount estimating unit 205 first estimates a residual energy amount at the start timing of future action plan execution. The start timing of future action plan execution is, for example, the timing of departure from the home on Sunday in FIGS. 4A to 4C.

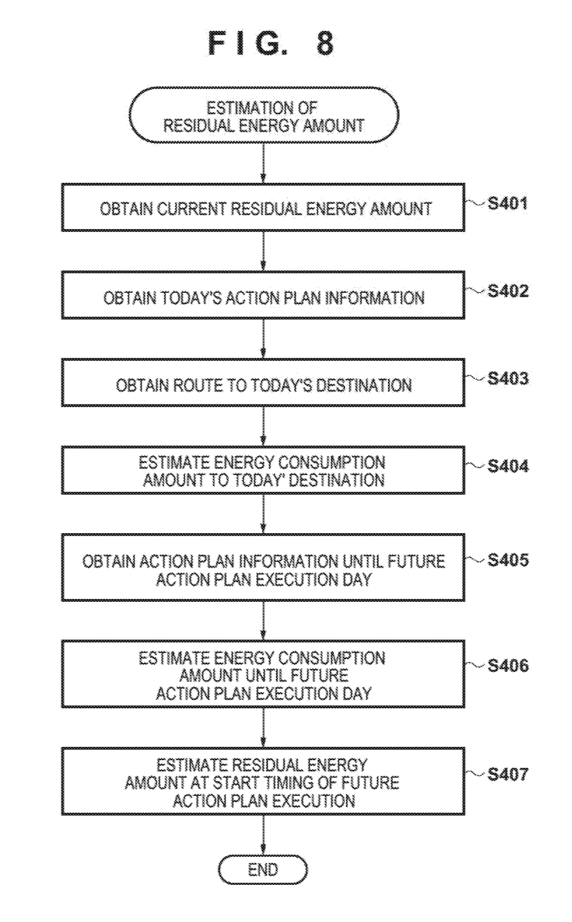

FIG. 8 is a flowchart showing a process of estimating the residual energy amount at the start timing of future action plan execution. In step S401, the energy amount estimating unit 205 obtains the current residual energy amount from the vehicle 104. For example, the current residual energy amount may also be obtained by periodically transmitting a request for the residual capacity of the battery 303, from the server 101 to the vehicle 104.

In step S402, the route estimating unit 206 obtains action plan information of the day (for example, Friday). The route estimating unit 206 may also refer to, for example, calendar information and SNS information stored in the storage unit 203. As the action plan information of the day, the route estimating unit 206 obtains, for example, action plan information “home-workplace-home”.

In step S403, the route estimating unit 206 obtains a route to the destination of the day. This destination is the destination of the current travel of the vehicle 104. For example, the destination is the home on Friday in FIGS. 4A to 4C. The route estimating unit 206 can obtain the route to the destination by referring to the map DB 207, and can also obtain route information indicated by the same action plan information in the past in the action log DB 208.

In step S404, the energy amount estimating unit 205 estimates an energy consumption amount until the destination of the day. As in step S403, this destination is the destination of the current travel of the vehicle 104, so the destination is the home on Friday in FIGS. 4A to 4C. The energy amount estimating unit 205 estimates the energy consumption amount until the destination of the day based on the route information, for example, distance information, estimated in step S403.

In step S405, the energy amount estimating unit 205 obtains action plan information of a day (for example, Saturday) before the future action plan execution day. The energy amount estimating unit 205 may also refer to the calendar information and SNS information stored in the storage unit 203. Note that this action plan information is not limited to travel of the vehicle 104 as long as the information is relevant to the use of the batter 303. For example, when the battery 303 is used as a storage battery of a household battery system or the like, this information is also obtained as the action plan information.

In step S406, the energy amount estimating unit 205 estimates an energy consumption amount before the future action plan execution day. The energy amount estimating unit 205 estimates this energy consumption amount before the future action plan execution day based on the action plan information obtained in step S405. Also, the self-discharge amount of the battery 303 may also be included in the energy consumption amount before the future action plan execution day.

In step S407, the energy amount estimating unit 205 estimates a residual energy amount at the start timing of future action plan execution. For example, the energy amount estimating unit 205 calculates a value obtained by subtracting the sum of the energy consumption amount until the destination of the day estimated in step S404 and the energy consumption amount before the future action plan execution day estimated in step S406, from the current residual energy amount obtained in step S401. After that, the process shown in FIG. 8 is terminated.

In step S104, the energy amount estimating unit 205 obtains a value by subtracting the energy consumption amount on the future action plan execution day estimated in step S103 from the residual energy amount at the start timing of future action plan execution estimated in step S407. This value is the residual energy amount after the execution of the action plan on the future action plan execution day.

In step S105, the processor 201 determines whether to notify the timing of energy replenishment (for example, charging of the battery 303), based on the residual energy amount after the execution of the action plan on the future action plan execution day estimated in step S104.

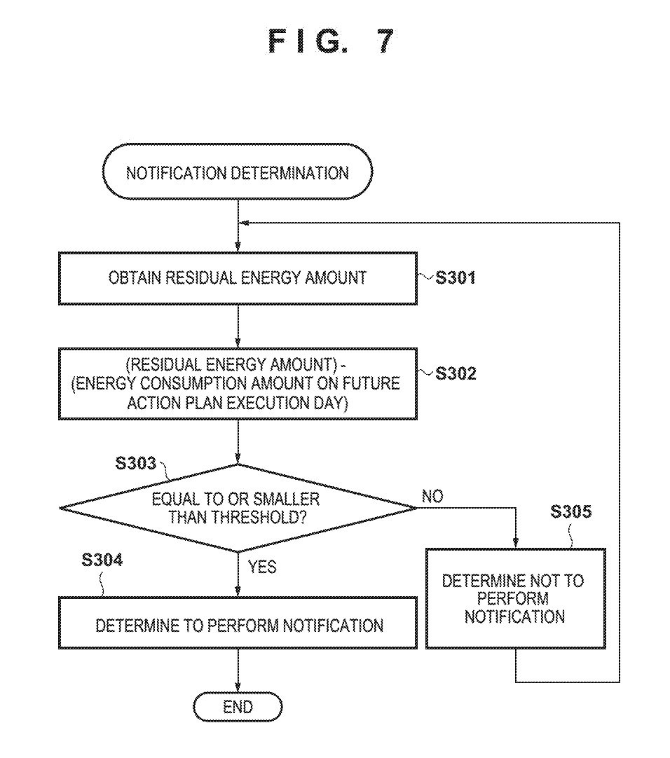

FIG. 7 is a flowchart showing the process of determining whether to notify the timing, of energy replenishment in step S105. In step S301, the processor 201 obtains the residual energy amount after the execution of the action plan on the future action plan execution day estimated in step S104.

In step S302, the processor 201 determines whether the residual energy amount after the execution of the action plan on the future action plan execution day obtained in step S301 is equal to or smaller than a threshold. If it is determined that the residual energy amount is equal to or smaller than the threshold, the process advances to step S304, and the processor 201 determines to notify the timing of energy replenishment. After that, the processor 201 terminates the process shown in FIG. 7. On the other hand, if it is determined that the residual energy amount is larger than the threshold, the process advances to step S305, and the processor 201 determines that this is not the notification timing of energy replenishment, that is, determines not to perform notification, and repeats the processing from step S301.

The threshold is, for example, 0. That is, if the difference in step S302 is 0 or less, this means that there is no residual energy amount, so the processor 201 determines to notify the timing of energy replenishment. However, the threshold may also be a predetermined positive value. For example, the threshold can be set based on the charging time. Assume that notification is performed in FIG. 4B because the residual capacity of the battery 303 is 30%, that is, 30% (residual capacity) −30% (consumption amount on Sunday)=0%, so the condition that the threshold is 0 or less is met, and charging is performed to 80% (charging of +80%) in FIG. 4C. However, it is also possible to perform notification by determining that the condition that the threshold is 30 or less is met if 60% (residual capacity) −30% (consumption amount on Sunday)=30%, and perform charging to 80% (charging of +50 in FIG. 4C. A configuration like this can shorten the charging time at the charging spot. In addition, the upper limit (for example, 80%) of the charging capacity of the battery 303 can be a full charge, and can also be set based on a margin for preventing overcharging and the consumption amount on the future action plan execution day.

If it is determined in step S304 that this is the notification timing of energy replenishment, the processor 201 transmits information indicating this and display data for displaying a message indicating the timing of energy replenishment, to the vehicle 104 via the wireless base station 103.

In step S106, the control unit 301 of the vehicle 104 receives the display data for displaying the message indicating the timing of energy replenishment from the server 101 via the wireless base station 103, and displays the message indicating the timing of energy replenishment on the HMI 308. This message can be a message “Why don't you replenish energy because energy is insufficient to go to golf on Sunday” as shown in FIG. 4B. It is also possible to notify information corresponding to the replenishing amount, for example, the replenishing time (charging time), together with the message. In addition to the above message, select buttons “replenish” and “do not replenish” are displayed so as to be acceptable. When the occupant selects one of these select buttons, information indicating the selection result is transmitted to the server 101 via the wireless base station 103. If information indicating the selection result “do not replenish” is received, the process 201 of the server 101 terminates the process shown in FIG. 5. On the other hand, if information indicating the selection “replenish” is received, the processor 201 plans energy replenishment in step S107.

In step S107, the processor 201 searches for a charging spot within a predetermined range from the current position of the vehicle 104 by referring to the map DB 207 based on the GPS information of the vehicle 104. If a plurality of charging spot candidates are found, the processor 201 ranks the plurality of charging spots based on attribute information. The contents of the attribute information are, for example, price information, the stay time, the charging time, and the distance from the current position of the vehicle 104. The stay time may also be obtained based on, for example, the degree of congestion of customers obtained based on IoT (Internet of Things) information by the processor 201. If extremely many charging spots are found within the predetermined range, it is also possible to score the charging spots based on the attribute information, and select only charging spots corresponding to predetermined higher ranks.

The processor 201 transmits display data for displaying the found charging spots to the vehicle 104 via the wireless base station 103. Based or the received display data, the control unit 301 of the vehicle 104 displays the found charging spots on the screen of the HMI 308. If the plurality of charging spots are ranked, they are displayed in accordance with the ranking. It is also possible to additionally display the attribute information such as the price information.

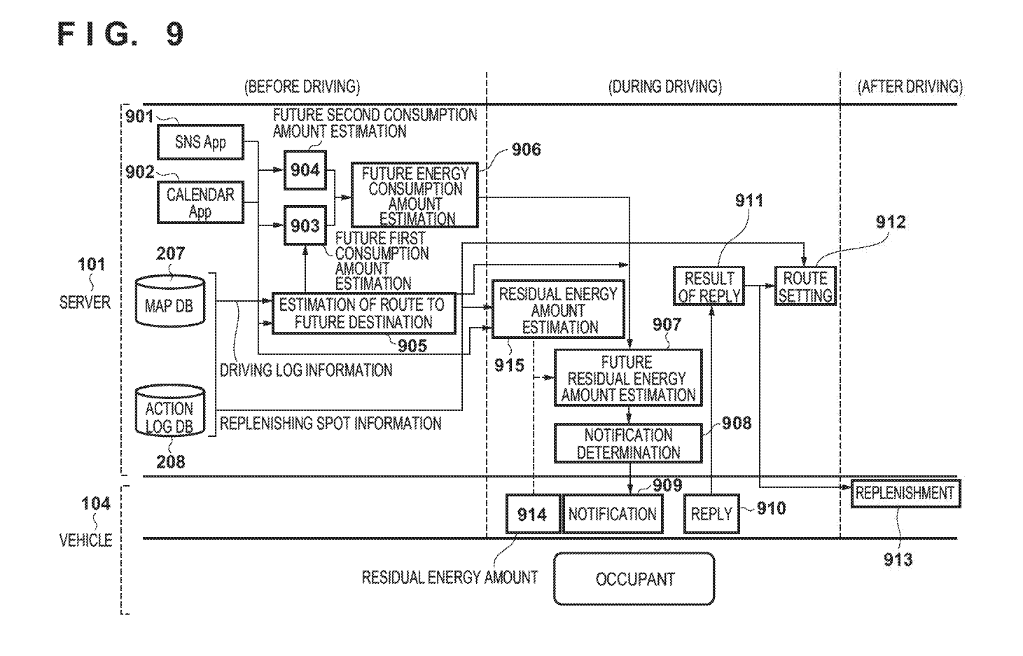

FIG. 9 is a view associating the operation of this embodiment with the driving state of the occupant. “Before driving” in FIG. 9 is a time before the occupant departs from the workplace on Friday in FIGS. 4A to 4C. “During driving” is a time during which the occupant is going home from the workplace on Friday in FIGS. 4A to 4C. “After driving”is a time after the occupant arrived at the home on Friday in FIGS. 4A to 4C.

A block 905 corresponds to step S102 in FIG. 5. Blocks 903, 904, and 906 respectively correspond to steps S201, S202, and S203 in FIG. 6. Note that blocks 901 and 902 are respectively SNS information and calendar information to be referred to when obtaining the future action plan information in step S101 of FIG. 5. As indicated by the blocks 903, 904, and 906 in FIG. 9, steps S102 and S103 shown in FIG. 5 can be performed before driving and can also be per during driving, that is, during the time in which the occupant is going home from the workplace on Friday in FIGS. 4A to 4C.

Further residual energy amount estimation in a block 907 corresponds to step S104 in FIG. 5. Also, residual energy amount estimation in a block 915 corresponds to the processing in FIG. 8. Referring to FIG. 8, it is sometimes unnecessary to take account of the energy consumption amount to the destination of the day. An example is the case of Friday in FIGS. 4A to 4C in which the distance to the home becomes a predetermined distance or less and no problem arises even if the consumption amount of the battery 303 to the home is not taken into consideration. In a case like this, the processes in steps S402 to 5404 may also be skipped in FIGS. 4A to 4C. It is also possible to skip the processes in steps S405 and S406 when the future action plan execution day is the following day.

When the processes in steps S402 to S406 are skipped in FIGS. 4A to 4C, the residual energy amount estimated in FIG. 8 at the start timing of future action plan execution becomes the current residual energy amount obtained in step S401. A residual energy amount in a block 914 of FIG. 9 represents the residual energy amount when the processes in steps S402 to S404 are skipped in FIGS. 4A to 4C.

Blocks 908 and 909 respectively correspond to steps S105 and S106 in FIG. 5. In the block 909, the HMI 308 accepts an instruction “replenish” or “do not replenish” from the occupant and transmits the accepted result to the server 101.

In FIG. 5 as explained above, when the server 101 receives information “replenish” from the vehicle 104, charging spot information is presented to the vehicle 104 based on the current position of the vehicle 104. The HMI 308 displays information of a plurality of charging spots, the occupant selects an arbitrary charging spot (a block 910), and information of the charging spot is transmitted to the server 101 via the wireless base station 103 (a block 911).

When accepting the information of the charging spot selected by the occupant, the processor 201 of the server 101 sets a route to the selected charging spot based on the current position of the vehicle 104, and transmits the setting information to the vehicle 104. In the vehicle 104, the HMI 308 displays the received setting information as route information. Alternatively, if the vehicle 104 is controlled by automated driving, the system of the vehicle 104 can also control travel of the vehicle based on the received setting information.

Furthermore, no charging spot may be found while the occupant is going home from the workplace. An example is a case in which a charging spot existing between the workplace and the home is crowded or not open. In this case, it is also possible to search for charging spots around the destination (home), and transmit the information to the vehicle 104. In addition, in this case, the block 909, that is, the notification in step S106 may also be performed after arrival at the destination. Furthermore, if the vehicle 104 is controlled by automated driving, the system of the vehicle 104 may also control travel of the vehicle from the destination to the charging spot based on the received information (a block 913).

The embodiment has been explained above. Note that the present invention is not limited to the abovementioned embodiment, and includes arrangements, changes, and modifications without departing from the spirit and scope of the invention. Note also that not all combinations of the features explained in the embodiment are essential to the present invention.

### SUMMARY OF EMBODIMENT

The notification system of the above embodiment comprises an obtaining unit (S101) configured to obtain a next use plan of a vehicle, which is made by a user of the vehicle, and a notification unit (S106) configured to, if it is determined based on the next use plan obtained by the obtaining unit that it is necessary to replenish driving energy of the vehicle, perform notification about replenishment of the driving energy of the vehicle during current use of the vehicle. The notification unit performs the notification about replenishment of the driving energy of the vehicle during current travel of the vehicle. The system further comprises a determination unit (FIG. 7) configured to determine, based on the next use plan obtained by the obtaining unit, whether it is necessary to replenish the driving energy of the vehicle.

With this configuration, if, for example, it is determined by taking account of the next use plan of the vehicle that it is necessary to replenish the driving energy of the vehicle, notification about replenishment of the driving, energy of the vehicle can be performed during current travel of the vehicle.

The determination unit determines whether it is necessary to replenish the driving energy of the vehicle, based on a residual amount of the driving energy after the current use of the vehicle, and a residual amount of the driving energy after execution of the next use plan.

With this configuration, whether it is necessary to charge the battery can be determined based on, for example, the residual battery amount in current travel of the vehicle, and the residual battery amount after execution of a use plan on the following day.

The determination unit determines whether it is necessary to replenish the driving energy of the vehicle, based on a residual amount of the driving energy after the current use of the vehicle, and an amount of the driving energy to be consumed by the next use plan.

With this configuration, whether it is necessary to charge the battery can be determined based on, for example, a residual battery amount after current use of the vehicle, and a battery amount to be consumed by a use plan on the following day.

The amount of the driving energy to be consumed by the next use plan includes a consumption amount of the driving energy necessary for travel of the vehicle, and a consumption amount of the driving energy necessary for a purpose other than travel of the vehicle.

With this configuration, a residual battery amount after execution of the use plan on the following day can be estimated based on, for example, the battery amount to be consumed by the use plan on the following day, that is, a battery consumption amount required for travel of the vehicle, and a battery amount to be consumed by charging of a portable apparatus.

The obtaining unit obtains the next use plan based on action plan information of the user. The action plan information contains calendar information and SNS information. With this configuration, the use plan of the following day can be obtained based on, for example, the calendar information and SNS information of the occupant.

The notification unit notifies a candidate of a replenishing place of the driving energy. The system further comprises a replenishing place obtaining unit configured to obtain a candidate of the replenishing place based on attribute information of the replenishing place, wherein the notification unit displays the candidate of the replenishing place obtained by the replenishing place obtaining unit on a display unit of the vehicle. The attribute information contains at least one of price information and distance information. With this configuration, it is possible to, for example, obtain a plurality of candidates of a battery charging spot based on the price information and the distance information, and display these candidates on the display unit.

The notification unit performs the notification when the vehicle is used on a day before an execution day of the next use plan. The notification unit performs the notification when the vehicle is moving on a return route as the current use of the vehicle. The notification unit performs the notification when or before the vehicle arrives at a destination of the return route. The notification unit informs that it is necessary to replenish the driving energy of the vehicle, as the notification. With this configuration, it is possible to notify that battery charging is necessary when, for example, the user is on a return route to the home on the day before the execution day of the use plan for the following day or the user arrives at the home.

The notification unit notifies information about a replenishing amount of the driving energy of the vehicle, in addition to the notification. With this configuration, it is possible to notify, for example, a battery charging time.

The driving energy of the vehicle is electric energy charged in a battery (FIG. 3). With this configuration, it is possible to notify, for example, the necessity of battery charging.

The notification system includes a server and the vehicle (FIG. 1), wherein the server comprises the obtaining unit, and the vehicle comprises the notification unit. With this configuration, the processing load of the vehicle can be reduced by assigning the processing to both the server and the vehicle.

What is claimed is:

1. A notification system comprising:
an obtaining unit configured to obtain a next use plan of a vehicle, which is made by a user of the vehicle; and
a notification unit configured to, if it is determined based on the next use plan obtained by the obtaining unit that it is necessary to replenish driving energy of the vehicle, perform notification about replenishment of the driving energy of the vehicle during current use of the vehicle.

2. The system according to claim 1, wherein the notification unit performs the notification about replenishment of the driving energy of the vehicle during current travel of the vehicle.

3. The system according to claim 1, further comprising a determination unit configured to determine, based on the next use plan obtained by the obtaining unit, whether it is necessary to replenish the driving energy of the vehicle.

4. The system according to claim 3, wherein the determination unit determines whether it is necessary to replenish the driving energy of the vehicle, based on a residual amount of the driving energy after the current use of the vehicle, and a residual amount of the driving energy after execution of the next use plan.

5. The system according to claim 4, wherein the determination unit determines whether it is necessary to replenish the driving energy of the vehicle, based on a residual amount of the driving energy after the current use of the vehicle, and an amount of the driving energy to be consumed by the next use plan.

6. The system according to claim 5, wherein the amount of the driving energy to be consumed by the next use plan includes a consumption amount of the driving energy necessary for travel of the vehicle, and a consumption amount of the driving energy necessary for a purpose other than travel of the vehicle.

7. The system according to claim 1, wherein the obtaining unit obtains the next use plan based on action plan information of the user.

8. The system according to claim 7, wherein the action plan information, contains calendar information and SNS information.

9. The system according to claim 1, wherein the notification unit notifies a candidate of a replenishing place of the driving energy.

10. The system according to claim 9, further comprising a replenishing place obtaining unit configured to obtain a candidate of the replenishing place based on attribute information of the replenishing place,
wherein the notification unit displays the candidate of the replenishing place obtained by the replenishing place obtaining unit on a display unit of the vehicle.

11. The system according to claim 10, wherein the attribute information contains at least one of price information, distance information, and a charging time.

12. The system according to claim 1, wherein the notification unit performs the notification when the vehicle is used on a day before an execution day of the next use plan.

13. The system according to claim 1, wherein the notification unit performs the notification when the vehicle is moving on a return route as the current use of the vehicle.

14. The system according to claim 13, wherein the notification unit performs the notification when or before the vehicle arrives at a destination of the return route.

15. The system according to claim 1, wherein as the notification, the notification unit informs that it is necessary to replenish the driving energy of the vehicle.

16. The system according to claim 1, wherein in addition to the notification, the notification unit notifies information about a replenishing amount of the driving energy of the vehicle.

17. The system according to claim 1, wherein the driving energy of the vehicle is electric energy charged in a battery.

18. The system according to claim 1, wherein
the notification system includes a server and the vehicle, and
the server comprises the obtaining unit, and the vehicle comprises the notification unit.

19. A notification method to be executed in a notification system which notifies replenishment of driving energy of a vehicle, comprising:
obtaining a next use plan of a vehicle, which is made by a user of the vehicle, and
if it is determined based on the next use plan obtained in the obtaining that it is necessary to replenish driving energy of the vehicle, performing notification about replenishment of the driving energy of the vehicle during current use of the vehicle.

20. A non-transitory computer-readable storage medium storing a program which causes a computer to function so as to:
obtain a next use plan of a vehicle, which is made by a user of the vehicle, and
if it is determined based on the obtained next use plan that it is necessary to replenish driving energy of the vehicle, perform notification about replenishment of the driving energy of the vehicle during current use of the vehicle.
